(19) United States
(12) Patent Application Publication
(10) Pub. No.: US 2022/0397471 A1
(43) Pub. Date: Dec. 15, 2022

(54) PRESSURE VESSEL STRAIN ANALYSIS DEVICE AND PRESSURE VESSEL MANUFACTURING METHOD

(71) Applicant: TOYOTA JIDOSHA KABUSHIKI KAISHA, Toyota-shi (JP)

(72) Inventors: Daisuke SATOYA, Nisshin-shi (JP); Takeshi ISHIKAWA, Toyokawa-shi (JP)

(73) Assignee: TOYOTA JIDOSHA KABUSHIKI KAISHA, Toyota-shi (JP)

(21) Appl. No.: 17/806,788

(22) Filed: Jun. 14, 2022

(30) Foreign Application Priority Data
Jun. 14, 2021 (JP) 2021-098451

(51) Int. Cl. G01L 5/00; F17C 1/00

(52) U.S. Cl. CPC G01L 5/0076; F17C 1/00; F17C 2209/00; F17C 2260/011; F17C 2260/017

(57) ABSTRACT

Provided is a pressure vessel strain analysis device capable of grasping a correlation between manufacturing conditions and strains. The pressure vessel strain analysis device includes an analysis unit. Based on a plurality of manufacturing conditions of a plurality of pressure vessels and a plurality of strains acquired by an image correlation method in a state where a predetermined internal pressure is applied to the plurality of pressure vessels manufactured under the plurality of manufacturing conditions, the analysis unit calculates a correlation between the plurality of manufacturing conditions and the plurality of strains.

### CROSS REFERENCE TO RELATED APPLICATIONS

The present application claims priority from Japanese patent application JP 2021-098451 filed on Jun. 14, 2021, the entire content of which is hereby incorporated by reference into this application.

### BACKGROUND

### Technical Field

The present disclosure relates to a pressure vessel strain analysis device and a pressure vessel manufacturing method.

### Background Art

Conventionally, a disclosure of an inspection method for a pressure vessel is known. JP 2020-153503 A discloses the following inspection method for a pressure vessel for the sake of providing a method for producing a pressure vessel in which the state of the produced pressure vessel may be easily determined in a non-destructive manner (Abstract, claim 1, paragraph 0007, for example). The pressure vessel to be inspected by this conventional inspection method includes a tubular straight drum part and dome parts provided at both ends of the straight drum part having a shape that narrows as the distance from the straight drum part increases. The straight drum part and the dome parts are formed of a container main body and a fiber-reinforced resin composite material layer provided on the outside of the container main body.

This conventional inspection method for a pressure vessel uses a group of pressure vessels including p pressure vessels (p is an integer of at least 3) produced based on the same design as a working pressure. For each pressure vessel in the group of pressure vessels, the method measures strains in a hoop direction at q positions (q is an integer of at least 3) including at least 3 different positions of the straight drum part in the axial direction in a state where a pressure of at least the above-mentioned working pressure is applied, and obtains a standard deviation of the measured strains. The method further determines the state of each pressure vessel by using the obtained standard deviation.

### SUMMARY

As the examples of a strain measuring method, JP 2020-153503 A discloses a strain gauge method, an optical fiber method, an image correlation method, and the like (paragraph 0043). The strain gauge method and the optical fiber method measure a strain of a pressure vessel with a sensing element, such as a strain gauge or an optical fiber, attached to or embedded in the pressure vessel.

Thus, in the strict sense, the strain gauge method and the optical fiber method cannot measure an actual strain of a pressure vessel that does not include a sensing element. In contrast, the image correlation method can measure an actual strain of a pressure vessel that does not include a sensing element. However, the image correlation method cannot grasp a correlation between manufacturing conditions and strains of pressure vessels.

The present disclosure provides a strain analysis device capable of grasping a correlation between manufacturing conditions and strains of pressure vessels, and a pressure vessel manufacturing method using the correlation.

One aspect of the present disclosure is a pressure vessel strain analysis device including an analysis unit configured to calculate a correlation between a plurality of manufacturing conditions of a plurality of pressure vessels and a plurality of strains acquired by an image correlation method in a state where a predetermined internal pressure is applied to the plurality of pressure vessels manufactured under the plurality of manufacturing conditions.

The pressure vessel strain analysis device according to the above aspect may include an input unit configured to receive a manufacturing condition of a pressure vessel to be analyzed; and a calculation unit configured to calculate, based on the manufacturing condition received in the input unit and the correlation calculated by the analysis unit, a predicted value of a strain acquired by an image correlation method in a state where the predetermined internal pressure is applied to the pressure vessel to be analyzed manufactured under the manufacturing condition received in the input unit.

In some embodiments of the pressure vessel strain analysis device according to the above aspect, the analysis unit calculates a correlation between a plurality of manufacturing conditions for each one of a plurality of analysis sections defined on each one of the plurality of pressure vessels and a plurality of strains in the respective analysis sections acquired by an image correlation method in a state where a predetermined internal pressure is applied to each one of the plurality of pressure vessels manufactured under the plurality of manufacturing conditions; the input unit receives a manufacturing condition for each one of the plurality of analysis sections of the pressure vessel to be analyzed, and the calculation unit calculates, based on the manufacturing condition received in the input unit and the correlation calculated by the analysis unit, a predicted value of a strain in each one of the plurality of analysis sections of the pressure vessel to be analyzed.

In some embodiments of the pressure vessel strain analysis device according to the above aspect, the analysis unit includes a machine learning unit configured to calculate the correlation through machine learning.

In the pressure vessel strain analysis device according to the above aspect, the plurality of manufacturing conditions may include at least one of contour information on a liner of the pressure vessel, a thickness of the liner, a winding condition of a fiber bundle impregnated with a thermoplastic resin to be wound around the liner when a fiber-reinforced resin layer of the pressure vessel is formed, or a void content of the fiber-reinforced resin layer after being formed.

Another aspect of the present disclosure is a pressure vessel manufacturing method, including: calculating a correlation between a plurality of manufacturing conditions of a plurality of pressure vessels and a plurality of strains acquired by an image correlation method in a state where a predetermined internal pressure is applied to the plurality of pressure vessels manufactured under the plurality of manufacturing conditions; calculating a manufacturing condition that satisfies that a strain of a pressure vessel to be newly manufactured is less than or equal to a predetermined value based on the correlation; and manufacturing a new pressure vessel using the calculated manufacturing condition.

According to the above aspects of the present disclosure, it is possible to provide a strain analysis device capable of grasping a correlation between manufacturing conditions and strains of pressure vessels, and a pressure vessel manufacturing method using the correlation.

### BRIEF DESCRIPTION OF THE DRAWINGS

FIG. 1 is a block diagram showing an embodiment of a pressure vessel strain analysis device according to the present disclosure;

FIG. 2 is a diagram illustrating manufacturing conditions of a pressure vessel entered into the strain analysis device of FIG. 1;

FIG. 3 is a diagram illustrating a strain of a pressure vessel entered into the strain analysis device of FIG. 1:

FIG. 4 is a graph showing an exemplary relation between an internal pressure and a strain of a pressure vessel; and

FIG. 5 is a flowchart of a pressure vessel manufacturing method according to the present disclosure.

### DETAILED DESCRIPTION

Hereinafter, an embodiment of a pressure vessel strain analysis device and a pressure vessel manufacturing method according to the present disclosure will be described with reference to the drawings.

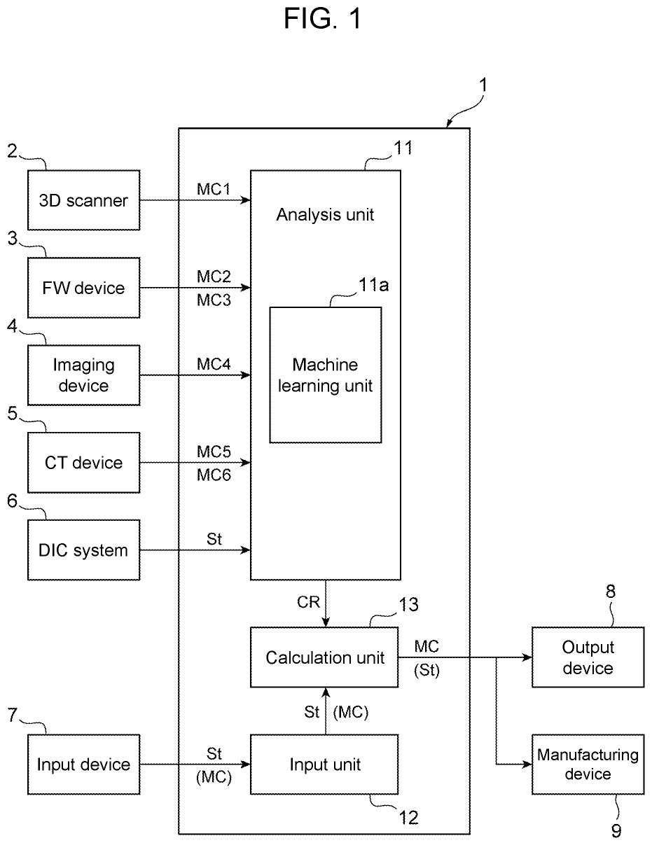

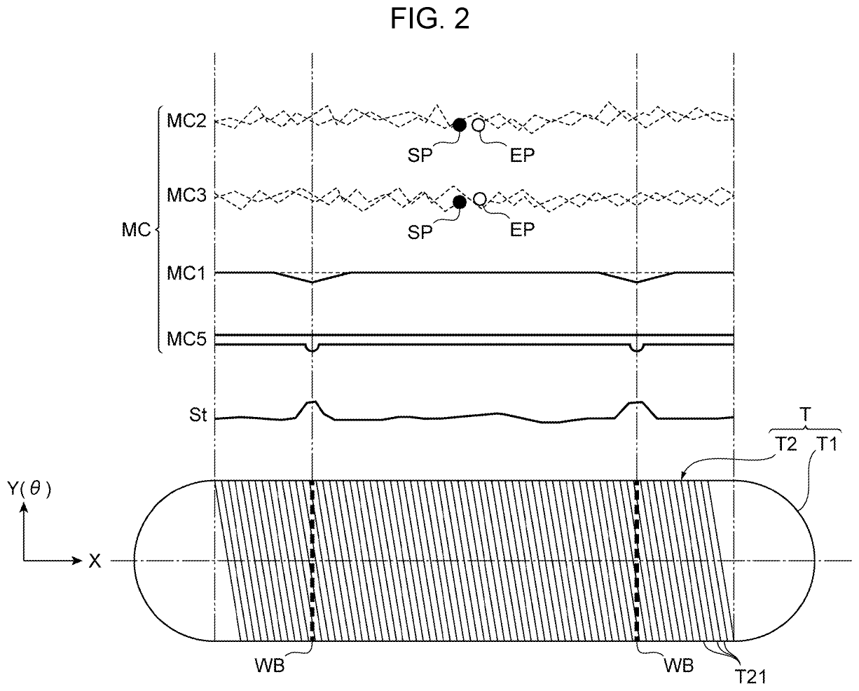

FIG. 1 is a block diagram showing an embodiment of a pressure vessel strain analysis device according to the present disclosure. FIG. 2 is a diagram illustrating manufacturing conditions MC of a pressure vessel entered into a strain analysis device 1 of FIG. 1. The strain analysis device 1 for analyzing strains of pressure vessels of the present embodiment includes an analysis unit 11 configured to calculate a correlation CR between a plurality of manufacturing conditions MC and a plurality of strains St of a plurality of pressure vessels. In the example shown in FIG. 1, the analysis unit 11 includes a machine learning unit 11a, and the strain analysis device 1 further includes an input unit 12 and a calculation unit 13.

The strain analysis device 1 of the present embodiment is a computer system including a microcontroller provided with a central processing unit (CPU), memory, a timer, and input/output units, for example. Each unit of the strain analysis device 1 of FIG. 1 shows a functional block of the strain analysis device 1 implemented by execution of programs stored in the memory by the CPU, for example.

In the example shown in FIG. 1, the strain analysis device 1 is coupled to a 3D scanner 2, a filament winding device (FW device 3), an imaging device 4, a computed tomography device (CT device 5), and a digital image correlation system (DIC system 6), for example. The strain analysis device 1 is also coupled to an input device 7, an output device 8, and a manufacturing device 9, for example. It should be noted that the strain analysis device 1 may include these devices as a data acquisition unit for acquiring manufacturing conditions MC and strains St of a plurality of pressure vessels T.

The pressure vessel T to be analyzed by the strain analysis device 1 is a high-pressure tank to be charged with a high-pressure hydrogen gas, for example. The pressure vessel T includes a liner T1 for storing a gas and a fiber-reinforced resin layer T2 covering the outer surface of the liner T1, for example. The fiber-reinforced resin layer T2 is formed by winding a fiber bundle T21 impregnated with a thermoplastic resin around the outer surface of the liner T1 by the FW device 3, for example. It should be noted that, though not shown in FIG. 2, the pressure vessel T includes an opening that serves as an inlet and outlet of a gas and a valve for opening and closing the opening.

The 3D scanner 2 is a device configured to acquire three-dimensional form data on a contour of the liner T1 by irradiating the liner T1 of the pressure vessel T with laser and detecting the laser reflected on the liner T1 by a sensor, for example. This three-dimensional form data on the contour of the liner T1 is entered into the strain analysis device 1 as form information on the liner T1 that is one of the manufacturing conditions MC of the pressure vessel T, for example. It should be noted that the form information on the liner T1 includes a liner profile MC1.

As shown in FIG. 2, for example, a point on the outer surface of the liner T1 may be expressed as a point on the XY coordinates, where the central axis of the cylindrical liner T1 is X-axis and the central angle θ around the central axis as the center is Y-axis. The liner profile MC1 can be represented as a distance from the central axis to the outer surface of the liner T1 at each point on the XY coordinates or a radius of the outer surface of the liner T1, for example.

In the example shown in FIG. 2, the liner profile MC1 indicates that the distance (radius) from the central axis to the outer surface of the liner T1 on and around a weld bead WB of the liner T1 is smaller than that of the other portion of the liner T1. Such a partial decrease in the radius of the outer surface of the liner T1 may occur when the weld bead WB on the outer surface of the liner T1 is flattened by grinding or the like, for example.

The FW device 3 is a device configured to supply the fiber bundle T21 impregnated with resin to the outer surface of the liner T1 at a predetermined supply rate, for example. In addition, in a state where a predetermined tension is applied to the fiber bundle T21, the FW device 3 winds the fiber bundle T21 at a predetermined position on the outer surface of the liner T1. The FW device 3 includes a rate sensor for detecting a supply rate of the fiber bundle T21 and a tension sensor for detecting a tension applied to the fiber bundle T21, for example.

As shown in FIG. 2, for example, the FW device 3 winds the fiber bundle T21 from the start point SP to the end point EP on the outer surface of the liner T1 and also detects and stores a tension MC2 and a supply rate MC3 during the winding of the fiber bundle T21. As shown in FIG. 1, for example, the FW device 3 enters both of the tension MC2 and the supply rate MC3 during the winding of the fiber bundle T21 into the strain analysis device 1. These tension MC2 and supply rate MC3 are included in the winding conditions of the fiber bundle T21 that are the manufacturing conditions MC of the pressure vessel T.

The imaging device 4 is a monocular camera or a stereo camera, for example, and is configured to detect positional information MC4 representing the XY coordinates of the fiber bundle T21 disposed on the outer surface of the liner T1 by the FW device 3 and enter the detected positional information MC4 into the strain analysis device 1 as one of the manufacturing conditions MC of the pressure vessel T. It should be noted that the imaging device 4 may be included in the FW device 3. In this case, the FW device 3 outputs the tension MC2 and the supply rate MC3 to the strain analysis device 1 for each piece of positional information MC4 detected by the imaging device 4.

The CT device 5 is a device configured to acquire an image of the cross section of the pressure vessel T perpendicular to the central axis of the pressure vessel T having the fiber-reinforced resin layer T2 formed thereon after the winding the fiber bundle T21 around the liner T1 ends, for example. In addition, the CT device 5 detects a thickness MC5 of the liner T1 and a void content MC6 based on the image of the cross section of the pressure vessel T, for example. Herein, the void content MC6 is a rate of voids of each fiber-reinforced resin layer T2, for example. The CT device 5 can detect a void of 0.1 mm or more, for example.

The CT device 5 enters the detected thickness MC5 of the liner T1 and void content MC6 into the strain analysis device 1 individually as one of the manufacturing conditions MC of the pressure vessel T. In the example shown in FIG. 2, the thickness MC5 of the liner T1 entered by the CT device 5 into the strain analysis device 1 indicates that the thickness of the portion including the weld bead WB of the liner T1 is greater than that of the other portion. It should be noted that the thickness MC5 of the liner T1 and the void content MC6 may be detected by the strain analysis device 1 or the other device by using the image of the cross section of the pressure vessel T acquired by the CT device 5, for example.

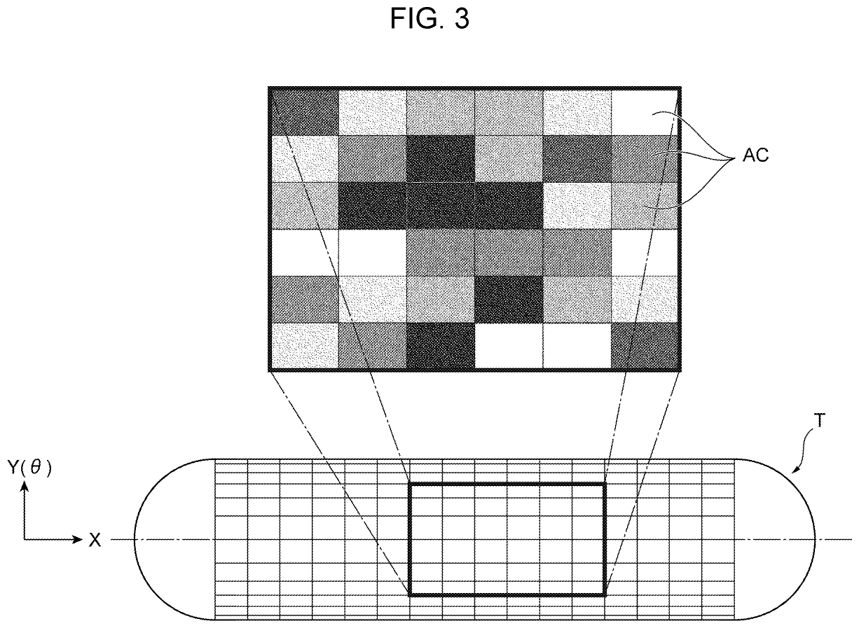

FIG. 3 is a diagram illustrating a strain St of the pressure vessel T entered into the strain analysis device 1 of FIG. 1. The DIC system 6 acquires a strain St of the pressure vessel T by the image correlation method in a state where a predetermined internal pressure is applied to the pressure vessel T manufactured under the above-stated manufacturing conditions MC. More specifically, first, in a state where an internal pressure is not applied to the pressure vessel T, that is, in a state where the opening of the pressure vessel T is open and the inside and outside of the pressure vessel T are communicated to each other, the DIC system 6 coats the outer surface of the pressure vessel T with random patterns called speckle patterns.

Then, in a state where an internal pressure is not applied to the pressure vessel T, the DIC system 6 starts capturing an image of the pressure vessel T coated with speckle patterns, feeds a gas, such as air, into the pressure vessel T from the opening of the pressure vessel T, and increases the internal pressure of the pressure vessel T. At this time, the internal pressure of the pressure vessel T is increased to, for example, a pressure lower than an acceptable maximum pressure of the pressure vessel T, more specifically, for example, a pressure of about 50% of the pressure that may cause rupture of the pressure vessel T.

The DIC system 6 acquires a strain St of the pressure vessel T by the image correlation method with the image before the internal pressure is applied to the pressure vessel T and the image while the internal pressure is applied to the pressure vessel T. Herein, the strain St of the pressure vessel T acquired by the DIC system 6 includes a strain in the X-axis direction and a strain in the Y-axis direction shown in FIG. 3, for example. FIG. 2 shows an example of the strain St in the X-axis direction of the pressure vessel T acquired by the DIC system 6. In this example, the strain St in the X-axis direction on and around the weld bead WB of the liner T1 is larger than that of the other portion.

In addition, as shown in FIG. 3, for example, the DIC system 6 acquires a strain St for each analysis section AC of a plurality of analysis sections AC defined on the pressure vessel T. In the example shown in FIG. 3, an analysis section AC having a larger strain St is expressed in a darker color close to black, and an analysis section AC having a smaller strain St is expressed in a lighter color closed to white. In practice, however, the magnitudes of the strain St can be expressed in various colors. The plurality of analysis sections AC defined on the surface of the pressure vessel T can be a plurality of rectangular areas defined by boundaries parallel to the X-axis direction and the Y-axis direction, for example. In addition, the sections may have various sizes depending on the position on the pressure vessel T.

Specifically, an analysis section AC on and around the weld bead WB of the liner T1 may have a smaller size than that of the other portion, for example. In this case, the analysis section AC on the weld bead WB in the X-axis direction may have a size smaller than the width of the weld bead WB, for example. In addition, the size of each analysis section AC may be determined based on the width of the fiber bundle T21 wound around the liner T1, for example.

Specifically, the size of the analysis section AC can be determined such that one analysis section AC is located in the Y-axis direction on the fiber bundle T21 that is wound in an inclined manner with respect to the Y-axis direction. This can prevent each analysis section AC from being smaller than required and can average the strains St in the analysis sections AC, thereby reducing the influence of the orientation of the fiber bundle T21.

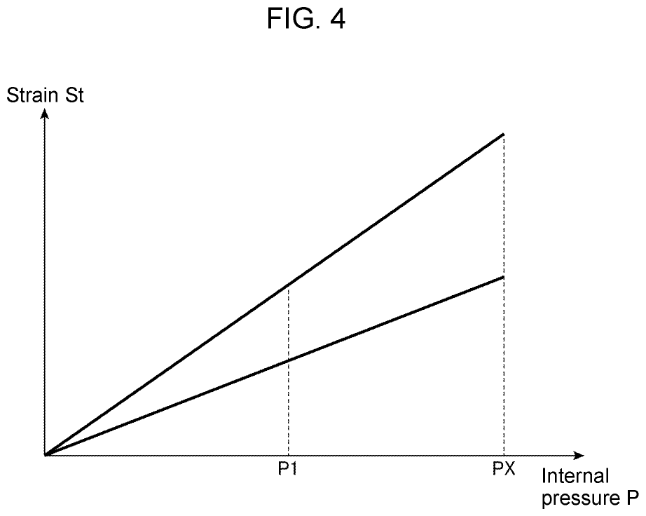

FIG. 4 is a graph showing an exemplary relation between an internal pressure P and a strain St of the pressure vessel T. Described herein is the reason why, when detecting a strain St of the pressure vessel T, the internal pressure P of the pressure vessel T is set to a low pressure P1 of about 50% of an internal pressure PX that may cause rupture of the pressure vessel T. In the graph of FIG. 4, the horizontal axis indicates the internal pressure P of the pressure vessel T and the vertical axis indicates the strain St of the pressure vessel T.

As shown in FIG. 4, there is a correlation between the internal pressure P1 during detection of the strain St of the pressure vessel T and the internal pressure PX that may cause rupture of the pressure vessel T. Accordingly, by repeating the detection of the strain St of the pressure vessel T and the rupture test of the pressure vessel T to accumulate data, a correlation between the internal pressure P1 during detection of the strain St of the pressure vessel T and the internal pressure PX at the rupture of the pressure vessel T can be obtained. Furthermore, based on the obtained correlation, the internal pressure PX at the rupture can be obtained from the internal pressure P1 during detection of the strain St.

The input device 7 shown in FIG. 1 includes, for example, a keyboard, a USB connector terminal, a disk drive, and the like. The input device 7 is used for entering a target value of the strain St or the like when a predetermined internal pressure P1 is applied to the pressure vessel T, for example. The output device 8 is an image display device, for example, and displays a calculation result of the strain St of the pressure vessel T, the manufacturing conditions MC of the pressure vessel T, and the like received from the strain analysis device 1. The manufacturing device 9 is a device for manufacturing the pressure vessel T including a device for manufacturing the liner T1, the FW device 3, and the like, for example, and receives the manufacturing conditions MC of the pressure vessel T from the strain analysis device 1.

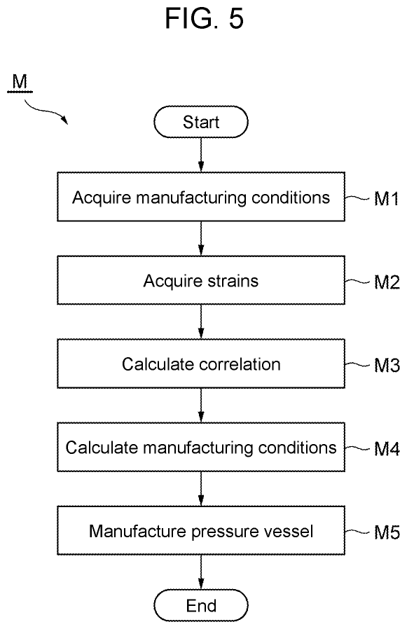

Hereinafter, operations of the strain analysis device 1 of the present embodiment and a manufacturing method M for manufacturing the pressure vessel T of the present embodiment will be described. FIG. 5 is a flowchart showing an embodiment of the pressure vessel manufacturing method M according to the present disclosure.

First, the strain analysis device 1 acquires a plurality of manufacturing conditions MC of a plurality of pressure vessels T (step M1). Specifically, with the analysis unit 11, for example, the strain analysis device 1 acquires the liner profile MC1 received from the 3D scanner 2 and the tension MC2 and the supply rate MC3 of the fiber bundle T21 received from the FW device 3. In addition, with the analysis unit 11, for example, the strain analysis device 1 acquires the positional information MC4 of the fiber bundle T21 received from the imaging device 4 and the thickness MC5 of the liner T1 and the void content MC6 received from the CT device 5.

Next, the strain analysis device 1 acquires a plurality of strains St of the plurality of pressure vessels T (step M2). Specifically, with the analysis unit 11, for example, the strain analysis device 1 acquires the strain St received from the DIC system 6. Herein, as described above, the strain St that the strain analysis device 1 acquires includes a plurality of strains St acquired by the image correlation method in a state where the predetermined internal pressure P1 is applied to the plurality of pressure vessels T manufactured under the plurality of manufacturing conditions MC acquired in the previous step M1.

Next, with the analysis unit 11, the strain analysis device 1 calculates a correlation CR between the plurality of manufacturing conditions MC acquired in the previous step M1 and the plurality of strains St acquired in the previous step M2 (step M3). Specifically, the analysis unit 11 uses the manufacturing conditions MC for each analysis section AC of the plurality of analysis sections AC defined on each pressure vessel T and the strain St in each analysis section AC acquired by the image correlation method in a state where the predetermined internal pressure P1 is applied to the pressure vessels T manufactured under the manufacturing conditions MC, for example. Table 1 below shows exemplary information used for the calculation of the correlation CR by the analysis unit 11.

TABLE 1

| | | | | | | Fiber bundle | | | |
|---|---|---|---|---|---|---|---|---|---|
| X-coordinate | Y-coordinate | Strain | | Liner | | | Supply | Void content | |
| [mm] | [°] | X-direction | Y-direction | Radius | Thickness | Tension | rate | (N layers) | . . . |
| 1 | 1 | * * * | * * * | * * * | * * * | * * * | * * * | * * * | * * * |
| 1 | 2 | * * * | * * * | * * * | * * * | * * * | * * * | * * * | * * * |
| 1 | 3 | * * * | * * * | * * * | * * * | * * * | * * * | * * * | * * * |
| 1 | 4 | * * * | * * * | * * * | * * * | * * * | * * * | * * * | * * * |
| . | . | . | . | . | . | . | . | . | . |
| . | . | . | . | . | . | . | . | . | . |
| . | . | . | . | . | . | . | . | . | . |

As shown in Table 1, the manufacturing conditions MC of the pressure vessel T include the radius of the liner T1 (liner profile MC1) and the thickness MC5 of the liner T1 corresponding to the position on the XY coordinates of the liner T1, the tension MC2 and the supply rate MC3 of the fiber bundle T21, and the void content MC6 of each fiber-reinforced resin layer, for example. As shown in Table 1, for example, the analysis unit 11 of the strain analysis device 1 stores in the memory the strains St at respective positions on the XY coordinates of the plurality of liners T1 or the plurality of pressure vessels T.

Herein, based on the manufacturing conditions MC for each analysis section AC of the plurality of analysis sections AC defined on each pressure vessel T and the strain St in each analysis section AC, the analysis unit 11 calculates a correlation CR between the manufacturing conditions MC and the strain St in each analysis section AC, for example. As shown in FIG. 1, for example, the analysis unit 11 includes the machine learning unit 11a. The machine learning unit 11a calculates, through machine learning, a correlation CR between the plurality of manufacturing conditions MC and the plurality of strains St.

Next, based on the correlation CR calculated by the analysis unit 11 in the previous step M3, the strain analysis device 1 calculates manufacturing conditions MC of a pressure vessel T to be analyzed that satisfy that the strain St of the pressure vessel T to be analyzed is less than or equal to a predetermined value (step M4). Herein, as shown in FIG. 4, for example, the predetermined value of the strain St of the pressure vessel T can be set to a value of the strain St when an internal pressure P1 of lower than or equal to 50% of a predetermined rupture pressure PX is applied to the pressure vessel T having the predetermined rupture pressure PX.

More specifically, as shown in FIG. 1, for example, the strain analysis device 1 enters a target value of the strain St of the pressure vessel T to be analyzed into the input unit 12 via the input device 7. Here, the pressure vessel T to be analyzed is a pressure vessel T to be newly manufactured, for example. Based on the target value of the strain St entered into the input unit 12 and the correlation CR calculated by the analysis unit 11, the calculation unit 13 calculates manufacturing conditions MC that satisfy that the strain St of the pressure vessel T to be analyzed is less than or equal to the target value, for example.

Herein, as shown in FIG. 3, for example, the target value of the strain St of the pressure vessel T to be entered into the input unit 12 of the strain analysis device 1 may be a target value of the strain St in each analysis section AC of the pressure vessel T. In this case, based on the target value of the strain St entered into the input unit 12 and the correlation CR calculated for each analysis section AC by the analysis unit 11, the calculation unit 13 calculates manufacturing conditions MC of the pressure vessel T that satisfy that the strain St in each analysis section AC is less than or equal to the target value.

Next, the strain analysis device 1 manufactures a pressure vessel T using the calculated manufacturing conditions MC (step M5). Specifically, as shown in Table 1, for example, the calculation unit 13 of the strain analysis device 1 outputs the calculated manufacturing conditions MC of the pressure vessel T to the output device 8 and the manufacturing device 9. As shown in Table 1 and FIG. 2, these manufacturing conditions MC of the pressure vessel T include the radius of the liner T1 (liner profile MC1) and the thickness MC5 of the liner T1 corresponding to the position on the XY coordinates of the liner T1, the tension MC2 and the supply rate MC3 of the fiber bundle T21, and the void content MC6 of each fiber-reinforced resin layer, for example.

The manufacturing device 9 manufactures a pressure vessel T based on the manufacturing conditions MC of the pressure vessel T received from the strain analysis device 1. It should be noted that the manufacturing conditions MC of the pressure vessel T may be entered into the manufacturing device 9 by an operator based on the manufacturing conditions MC of the pressure vessel T displayed on the output device 8, for example. The pressure vessel manufacturing method M shown in FIG. 5 ends through the above-described process.

In addition, the strain analysis device 1 may also calculate a predicted value of the strain St of a pressure vessel T to be analyzed based on the manufacturing conditions MC of the pressure vessel T. Herein, the pressure vessel T to be analyzed is a pressure vessel T that has been newly manufactured, for example. Specifically, for example, the strain analysis device 1 enters the manufacturing conditions MC of the pressure vessel T to be analyzed as shown in Table 1 into the input unit 12 shown in FIG. 1. Based on the manufacturing conditions MC of the pressure vessel T entered into the input unit 12 and the correlation CR calculated by the analysis unit 11, the calculation unit 13 calculates a predicted value of the strain St of the pressure vessel T to be manufactured under the received manufacturing conditions MC.

Herein, the manufacturing conditions MC of the pressure vessel T to be entered into the input unit 12 of the strain analysis device 1 via the input device 7 may be, for example, the manufacturing conditions MC for each analysis section AC of the pressure vessel T. In this case, based on the manufacturing conditions MC in each analysis section AC entered into the input unit 12 and the correlation CR calculated by the analysis unit 11, the calculation unit 13 calculates a predicted value of the strain in each analysis section AC of the pressure vessel T to be manufactured under the received manufacturing conditions MC.

As described above, the strain analysis device 1 of the present embodiment includes the analysis unit 11. The analysis unit 11 calculates a correlation CR between the plurality of manufacturing conditions MC of the plurality of pressure vessels T and the plurality of strains St acquired by the image correlation method in a state where the internal pressure P1 is applied to the plurality of pressure vessels T manufactured under the plurality of manufacturing conditions MC, as described above.

Such a configuration allows the strain analysis device 1 of the present embodiment to grasp the correlation CR between the manufacturing conditions MC and the strains St of the pressure vessels T. Accordingly, the strain analysis device 1 can calculate a predicted value of the strain St based on the grasped correlation CR and the manufacturing conditions MC of the pressure vessels T, without conducting a pressurizing test. Furthermore, based on the grasped correlation CR and a target value of the strain St of the pressure vessel T, the strain analysis device 1 can calculate manufacturing conditions MC to achieve the target value of the strain St.

In addition, the strain analysis device 1 of the present embodiment includes the input unit 12 and the calculation unit 13. The input unit 12 receives the manufacturing conditions MC of the pressure vessel T to be analyzed. Based on the manufacturing conditions MC entered into the input unit 12 and the correlation CR calculated by the analysis unit 11, the calculation unit 13 calculates a predicted value of the strain St acquired by the image correlation method in a state where the predetermined internal pressure P1 is applied to the pressure vessel T to be analyzed that has been manufactured under the manufacturing conditions MC entered into the input unit 12.

With such a configuration, by entering the manufacturing conditions MC of the pressure vessel T to be analyzed into the input unit 12, the strain analysis device 1 can calculate a predicted value of the strain St of the pressure vessel T manufactured under the manufacturing conditions MC by the calculation unit 13. This no longer requires increasing the internal pressure of the pressure vessel T to acquire the strain St. In addition, by entering a predetermined strain St into the input unit 12, the strain analysis device 1 can calculate manufacturing conditions MC of the pressure vessel T that can achieve the predetermined strain St by the calculation unit 13. Accordingly, it is possible to manufacture the pressure vessels T based on the manufacturing conditions MC calculated by the calculation unit 13 and manufacture the pressure vessels T that can achieve the target value of the predetermined strain St under the predetermined internal pressure P1.

In addition, in the strain analysis device 1 of the present embodiment, the analysis unit 11 calculates a correlation CR between the plurality of manufacturing conditions MC for each analysis section AC of the plurality of analysis sections AC defined on each pressure vessel T of the plurality of pressure vessels T and the plurality of strains in the respective analysis sections AC acquired by the image correlation method in a state where the predetermined internal pressure P1 is applied to each pressure vessel T manufactured under the plurality of manufacturing conditions MC. In addition, the input unit 12 receives the manufacturing conditions MC for each analysis section AC of the pressure vessel T to be analyzed. Then, based on the manufacturing conditions MC entered into the input unit 12 and the correlation CR calculated by the analysis unit 11, the calculation unit 13 calculates a predicted value of the strain St in each analysis section AC of the pressure vessel T to be analyzed.

With such a configuration, changing the size of the analysis section AC according to the event for which analysis of the pressure vessel T is required allows the strain analysis device 1 to more precisely grasp the correlation CR between the manufacturing conditions MC and the strains St of the pressure vessels T. Specifically, for example, the size of the analysis section AC in the X-axis direction in an area cut out for the weld bead WB in the liner T1 can be set smaller than the width of the weld bead WB, and the size of the analysis section AC in the X-axis direction in another area can be set larger than the analysis section AC in the cut area. Accordingly, it is possible to precisely grasp the influence on the strains St in the cut area and the weld bead WB and prevent an adjacent analysis section AC in another area from including the same value in duplicate, thus allowing the strain analysis device 1 to grasp more precisely the correlation CR between the manufacturing conditions MC and the strains St.

It should be noted that the size of the analysis section AC may be larger than the size of a void that may occur in the fiber-reinforced resin layer of the pressure vessel T, for example. Regarding the size of the void, the diameter is about 0.1 mm, for example. In addition, the size of the analysis section AC may be smaller than the width of the fiber bundle to be wound around the liner T1 of the pressure vessel T. For example, when the width of the fiber bundle is about 9 mm, the size of the analysis section AC in the X-axis direction can be set to about 4 mm, which is smaller than half of the width of the fiber bundle.

In addition, in the strain analysis device 1 of the present embodiment, the analysis unit 11 includes the machine learning unit 11a configured to calculate a correlation CR between the manufacturing conditions MC and the strains St by machine learning.

With such a configuration, the strain analysis device 1 can more precisely grasp the correlation CR between the manufacturing conditions MC and the strains St as compared to the case where the strain analysis device 1 does not perform machine learning. In addition, as described above, acquiring strains St in the plurality of analysis sections AC defined on the pressure vessel T can increase the number of pieces of teacher data in machine learning that can be acquired from a single pressure vessel T. and can increase the analysis precision of the correlation CR.

In addition, in the strain analysis device 1 of the present embodiment, the manufacturing condition MC of the pressure vessel T includes at least one of the contour information on the liner T1 of the pressure vessel T, the thickness MC5 of the liner T1, the winding condition of the fiber bundle, or the void content MC6 of the formed fiber-reinforced resin layer, as shown in Table 1. It should be noted that the contour information on the liner T1 includes the aforementioned liner profile MC1, for example. In addition, the fiber bundle is a fiber bundle impregnated with a thermoplastic resin wound around the liner T1 when forming the fiber-reinforced resin layer of the pressure vessel T. and the winding condition includes the tension MC2 and the supply rate MC3 of the fiber bundle, for example.

With such a configuration, the strain analysis device 1 can grasp the correlation CR between the above-described manufacturing conditions MC and the strains St. Therefore, the strain analysis device 1 can calculate the strain St from the above-described manufacturing conditions MC or calculate the above-described manufacturing conditions MC from a target value of the predetermined strain St.

In addition, as described above, the pressure vessel manufacturing method M of the present embodiment calculates a correlation CR between the plurality of manufacturing conditions MC and the plurality of strains St based on the manufacturing conditions MC of the plurality of pressure vessels T and the plurality of strains St acquired by the image correlation method in a state where the predetermined internal pressure P1 is applied to the plurality of pressure vessels T manufactured under the plurality of manufacturing conditions MC (step M1 through step M3). In this pressure vessel manufacturing method M, the method further calculates manufacturing conditions MC that satisfy that the strain St of the pressure vessel T to be newly manufactured is smaller than or equal to a predetermined value based on the calculated correlation CR (step M4), and then manufactures a new pressure vessel T by using the calculated manufacturing conditions MC (step M5).

With such a configuration, according to the pressure vessel manufacturing method M of the present embodiment, it is possible to manufacture the pressure vessel T under the manufacturing conditions MC that can achieve the target value of the strain St of the pressure vessel T, thus significantly increasing the productivity of the pressure vessels T.

As described above, according to the present embodiment, it is possible to provide the strain analysis device 1 for the pressure vessel T capable of grasping the correlation CR between the manufacturing conditions MC and the strains St, and the pressure vessel manufacturing method M using the correlation CR between the manufacturing conditions MC and the strains St.

That is a detailed description of the embodiment of the pressure vessel strain analysis device and the pressure vessel manufacturing method according to the present disclosure, with reference to the drawings. The specific configuration of the present disclosure is not limited to the above-stated embodiment, and the design may be modified variously without departing from the spirits of the present disclosure. The present disclosure also covers such modified embodiments.

For example, in the foregoing embodiment, the example in which the internal pressure P1 is applied to complete pressure vessels T to acquire the strains St of the pressure vessels T by the image correlation method has been described. However, the strains St may be acquired by applying the internal pressure P1 to the pressure vessels T before they are completed.

Specifically, for example, suppose that the lamination number of fiber-reinforced resin layers of each complete pressure vessel T is 25. In this case, for example, the fiber bundle is wound around the liner T1 in helical winding to form a first fiber-reinforced resin layer, then the fiber bundle is wound thereon in hoop winding to form second to fifth fiber-reinforced resin layers, and then the fiber bundle is wound thereon in helical winding to form a sixth fiber-reinforced resin layer.

As described above, the strain analysis device 1 may calculate a correlation CR between the manufacturing conditions MC and the strains St of the pressure vessels T by applying the internal pressure P1 to uncomplete pressure vessels T each partially having fiber-reinforced resin layers. With such a configuration, the strain analysis device 1 can easily acquire a correlation CR between the strains St and the manufacturing conditions MC. This is because in terms of the structure of the pressure vessel T, a larger stress acts on the fiber-reinforced resin layers closer to the liner T1 due to the internal pressure P1.

DESCRIPTION OF SYMBOLS

| | |
|---|---|
| 1 | Strain analysis device |
| 11 | Analysis unit |
| 11a | Machine learning unit |
| 12 | Input unit |
| 13 | Calculation unit |
| AC | Analysis section |
| CR | Correlation |
| M | Pressure vessel manufacturing method |
| MC | Manufacturing condition |
| MC1 | Liner profile (liner contour information) |
| MC2 | Winding condition of fiber bundle (tension) |
| MC3 | Winding condition of fiber bundle (supply rate) |
| MC5 | Thickness of liner |
| MC6 | Void content |
| P1 | Internal pressure |
| St | Strain |
| T | Pressure vessel |

What is claimed is:

1. A pressure vessel strain analysis device, comprising:
an analysis unit configured to calculate a correlation between a plurality of manufacturing conditions of a plurality of pressure vessels and a plurality of strains acquired by an image correlation method in a state where a predetermined internal pressure is applied to the plurality of pressure vessels manufactured under the plurality of manufacturing conditions.

2. The pressure vessel strain analysis device according to claim 1, comprising:
an input unit configured to receive a manufacturing condition of a pressure vessel to be analyzed; and
a calculation unit configured to calculate, based on the manufacturing condition received in the input unit and the correlation calculated by the analysis unit, a predicted value of a strain acquired by an image correlation method in a state where the predetermined internal pressure is applied to the pressure vessel to be analyzed manufactured under the manufacturing condition received in the input unit.

3. The pressure vessel strain analysis device according to claim 2, wherein:
the analysis unit calculates a correlation between a plurality of manufacturing conditions for each one of a plurality of analysis sections defined on each one of the plurality of pressure vessels and a plurality of strains in the respective analysis sections acquired by an image correlation method in a state where a predetermined internal pressure is applied to each one of the plurality of pressure vessels manufactured under the plurality of manufacturing conditions;
the input unit receives a manufacturing condition for each one of the plurality of analysis sections of the pressure vessel to be analyzed; and
the calculation unit calculates, based on the manufacturing condition received in the input unit and the correlation calculated by the analysis unit, a predicted value of a strain in each one of the plurality of analysis sections of the pressure vessel to be analyzed.

4. The pressure vessel strain analysis device according to claim 1, wherein the analysis unit includes a machine learning unit configured to calculate the correlation through machine learning.

5. The pressure vessel strain analysis device according to claim 1, wherein the plurality of manufacturing conditions includes at least one of contour information on a liner of the pressure vessel, a thickness of the liner, a winding condition of a fiber bundle impregnated with a thermoplastic resin to be wound around the liner when a fiber-reinforced resin layer of the pressure vessel is formed, or a void content of the fiber-reinforced resin layer after being formed.

6. A pressure vessel manufacturing method, comprising:
calculating a correlation between a plurality of manufacturing conditions of a plurality of pressure vessels and a plurality of strains acquired by an image correlation method in a state where a predetermined internal pressure is applied to the plurality of pressure vessels manufactured under the plurality of manufacturing conditions;
calculating a manufacturing condition that satisfies that a strain of a pressure vessel to be newly manufactured is less than or equal to a predetermined value based on the correlation; and
manufacturing anew pressure vessel using the calculated manufacturing condition.
